(19) United States
(12) Patent Application Publication
(10) Pub. No.: US 2025/0106805 A1
(43) Pub. Date: Mar. 27, 2025

(54) TECHNOLOGIES FOR TRANSMISSION OF AUDIO AND RANGING SIGNALS

(71) Applicant: Apple Inc., Cupertino, CA (US)

(72) Inventors: Murat Mese, Atherton, CA (US); Igor V. Ryshakov, Mountain View, CA (US)

(73) Assignee: Apple Inc., Cupertino, CA (US)

(21) Appl. No.: 18/642,568

(22) Filed: Apr. 22, 2024

Related U.S. Application Data
(60) Provisional application No. 63/540,321, filed on Sep. 25, 2023.

(51) Int. Cl. H04W 64/00; H04W 74/04

(52) U.S. Cl. CPC H04W 64/00; H04W 74/04

(57) ABSTRACT

The present application relates to devices and components, including apparatus, systems, and techniques for joint transmission of audio data and ranging signals. The transmitter may use multicasting to transmit the audio data and ranging signal(s) to one or more devices. The transmitter may use a daisy chain transmission scheme in which the transmitting device may include the audio data of one or more devices in the payload and send them to one receiving device.

### CROSS-REFERENCES TO OTHER APPLICATIONS

This application claims priority to U.S. Provisional Application No. 63/540,321, for “TECHNOLOGIES FOR TRANSMISSION OF AUDIO AND RANGING SIGNALS” filed on Sep. 25, 2023, which is herein incorporated by reference in its entirety for all purposes.

### TECHNICAL FIELD

This application relates generally to communication and ranging technologies, particularly technologies for transmitting audio data in ranging packets.

### BACKGROUND

There are several technologies related to local and short-range ranging and localizations. One of the technologies is indoor localization techniques, which include methods and algorithms such as angle of arrival (AoA), time of arrival (ToA), and received signal strength (RSS). These techniques are used in various environments like supermarkets, airports, train stations, and hospitals. Other technologies include satellite-based navigations, inertial navigation systems, magnetic-based navigations, sound-based, optical-based, and radio frequency (RF)-based technologies.

In addition, there are also short-range wireless technologies, including Wi-Fi, Bluetooth Low Energy (BLE), Zigbee, and Thread (which, like Zigbee, runs on the IEEE 802.15-compliant radios). These technologies represent the mainstream short-range wireless technologies. Other technologies such as ultra-wideband (UWB), near field communication (NFC), wireless M-Bus, Z-Wave, and Wi-SUN are also considered for other niche applications.

### BRIEF DESCRIPTION OF THE DRAWINGS

The following description includes a discussion of figures having illustrations given by way of examples of implementations. The drawings should be understood by way of example and not by way of limitation. As used herein, references to one or more examples are to be understood as describing a particular feature, structure, or characteristic included in at least one implementation of the invention. Phrases such as “in one example” or “in an alternative example” appear herein to provide examples of implementations of the invention and do not necessarily all refer to the same implementation. However, they are also not necessarily mutually exclusive.

FIG. 1 illustrates a network environment in accordance with some embodiments.

FIG. 2 illustrates a packet frame structure in accordance with some embodiments.

FIG. 3 illustrates ranging signaling in accordance with some embodiments.

FIG. 4 illustrates an audio and ranging signaling diagram in accordance with some embodiments.

FIG. 5 illustrates an audio and ranging signaling diagram in accordance with some embodiments.

FIG. 6. illustrates a retransmission diagram in accordance with some embodiments.

FIG. 7. illustrates a retransmission diagram in accordance with some embodiments.

FIG. 8. illustrates a flow diagram in accordance with some embodiments.

FIG. 9. illustrates a flow diagram in accordance with some embodiments.

FIG. 10. illustrates a flow diagram in accordance with some embodiments.

FIG. 11 illustrates a block diagram in accordance with some embodiments.

### DETAILED DESCRIPTION

In the following description, various examples will be described. For purposes of explanation, specific configurations and details are set forth in order to provide a thorough understanding of the examples. However, it will also be apparent to one skilled in the art that the examples may be practiced without the specific details. Furthermore, well-known features may be omitted or simplified so as not to obscure the example being described.

Examples of the present disclosure are directed to, among other things, methods, systems, devices, and computer-readable storage media for performing joint transmission of data and ranging in one packet. In particular, data having ultra-low latency requirements, e.g., such as audio data, may be transmitted in the same packet with the ranging signal.

The term “joint transmission” of different data may be used to express a packet transmission where the packet includes different data. For example, joint transmission of audio data and ranging signal may be used to express transmission of both audio data and ranging signal in one packet. The audio data and ranging signal may be multiplexed, interleaved, or jointly coded.

The term “ranging signal” may be used to express symbols or signals in a packet associated with the ranging operation.

In one example scenario, consider that several friends are sitting in a café and are engaged in a conversation. Due to the noisy environment, they are wearing headphones (e.g., earbuds). The earbuds may be capable of broadcasting its user's voice to other people in the group. Further, the earbuds may be capable of performing ranging operations (e.g., determining relative distance and direction from one another). For example, the earbuds may regularly perform ranging operations to experience the natural speaker's relative direction (relative to the earbud's user) to adjust or configure the earbud's settings based on the speaker's relative direction to add the effect of the direction in the audio played by the earbuds. As a result, although the speaker's earbud may capture and transmit the speaker's voice and the other friend's earbud receives and replays the speaker's voice, the friend could estimate the relative direction of the speaker. For example, if the speaker calls the friend's name, the friend can turn towards where the speaker is located. It is desired that the power consumption of the devices be reduced to extend the operation time while satisfying the latency requirements of the audio data transmission.

### I. Overview

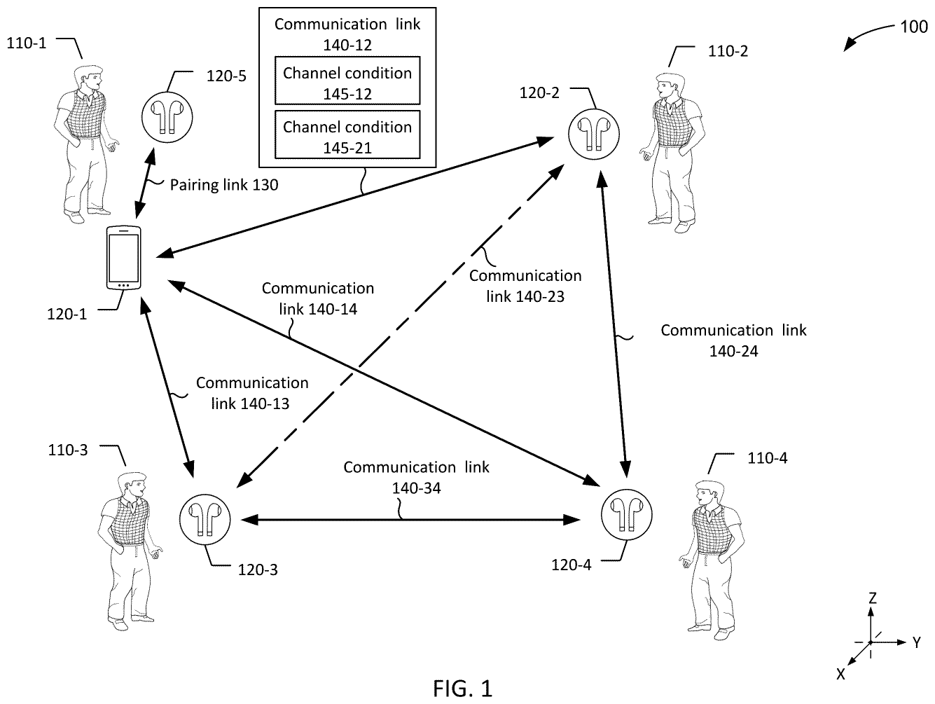

FIG. 1 illustrates a network environment 100 in accordance with some embodiments. The network environment 100 may include users 110, e.g., users 110-1, 110-2, 110-3, and 110-4. Each user may be associated with one or more devices 120. For example, user 110-1 is associated with devices 120-1 and 120-5, user 110-2 is associated with device 120-2, user 110-3 is associated with device 120-3, and user 110-4 is associated with device 120-4.

Devices 120-1 and 120-5 may be paired or coupled with one another through the paring link 130. The air interface of pairing link 130 may be based on Wi-Fi, Bluetooth (BT), Bluetooth low energy (BLE), UWB, Zigbee, or other wireless communication based on standards or proprietary technologies. Devices 120-1 and 120-5 may exchange data or control information on pairing link 130. For example, device 120-1 may be a smartphone, and device 120-5 may be an earbud, where the earbud 120-5 is paired with the smartphone 120-1 by the link 130. Smartphone 120-1 may send audio data or control commands to the earbud 120-5, and earbud 120-5 may send control information and user or environment audio data to smartphone 120-1.

A user's device may be communicatively coupled with another user's device through a communication link. For example, device 120-1 may be communicatively coupled with device 120-2 through communication link 140-12, with device 120-3 through communication link 140-13, and with device 120-4 through communication link 140-14. Device 120-2 may be communicatively coupled with device 120-1 through communication link 140-12, with device 120-3 through communication link 140-23, and with device 120-4 through communication link 140-24. Device 120-3 may be communicatively coupled with device 120-1 through communication link 140-13, with device 120-2 through communication link 140-23, and with device 120-4 through communication link 140-34. Similarly, device 120-4 may be communicatively coupled with device 120-1 through communication link 140-14, device 120-2 through communication link 140-24, and device 120-3 through communication link 140-34. Devices 120 may directly communicate with each other, or they may communicate indirectly through paired devices. For example, device 120-2 may directly communicate with device 120-4 or may indirectly communicate with device 120-5 through device 120-1. In one example, communication links 140 may use the same protocol or standard. For example, communication links 140 may use UWB, BT, BLT, Wi-Fi, Zigbee, or other standard or proprietary standard air interfaces or protocols.

In some examples, a channel condition may be associated with a communication link. For example, channel condition 145-12 may be associated with the communication link 140-12. In some examples, channel condition 145-12 may be associated with communication link 140-12 when device 120-1 is the transmitter and device 120-2 is the receiver, and channel condition 145-21 may be associated with communication link 140-12 when device 120-2 is the transmitter and device 120-1 is the receiver. In some examples, channel conditions 145-12 and 145-21 may be the same. In some examples, channel conditions 145-12 and 145-21 may be different. Other channel conditions are not shown in FIG. 1. However, each communication link 140 or pairing link 130 may have corresponding channel conditions. Channel condition may describe how a signal propagates from the transmitter to the receiver and may represent a combined effect of various factors such as scattering, fading, and power decay with distance. The channel condition can vary over time and frequency. The channel condition may be associated with the signal-to-noise ratio (SNR) at the receiver side of a communication link.

A transmitting device, e.g., device 120-1 may use the channel condition, e.g., channel condition 145-12, to determine the transmission configuration. Device 120-1 may determine the transmission configuration based on channel condition 145-12 to meet the quality of service or other requirements such as latency, data rate, or error rate. The transmission configuration may include transmit power, coding and modulation scheme, number of transmit antennas, or beamforming or pre-coding.

In one example, devices 120 may be earbuds or smart glasses, and communication links 140 may carry the audio data among the devices. For example, users 110 may be in a crowded and noisy environment, and to facilitate conversation, they may use the noise-canceling feature of their earbuds and the communication links 140 to transfer the audio data associated with the voices of the users 110.

In one example, devices 120 may use communication links 140 for ranging. The ranging procedure may provide information such as the distance between two devices and the relative position of one device with respect to another. For example, device 120-2 may perform ranging and find the relative position of devices 120-1, 120-3, and 120-4 with respect to its position.

In one example, the relative position may be expressed in cartesian, polar, cylindrical, or spherical coordinates. For example, when the device 120-2 measures or estimates the relative position of other devices, it may assume that it is located at the origin of the coordinate system. A relative position of another device in a spherical coordinate system, (r, q, f), may be represented by its radial distance, r, e.g., the slant distance to the origin, its polar angle, q, e.g., angle with respect to the polar axis or horizon and azimuthal angle, f, e.g., angle of rotation from the initial meridian plane. The relative position may be expressed by Euler angles or quaternion.

Devices 120 may use the relative positions to create a surround sound experience. For example, device 120-2 may use the relative position of device 120-4 to present the audio data to user 110-2 as if the audio data is coming from the direction of user 110-4. This is in contrast with when the audio data is presented without directionality.

Sometimes, the ranging signals are transmitted during a measurement gap. During the measurement gap, only the ranging signal is transmitted. The measurement gap may provide a controlled environment with reduced interference caused by other transmissions to increase the accuracy of the ranging. In some instances, the packets carrying ranging signals are very short, and the ranging procedure can be performed in a short amount of time.

In some instances, the data packets transmitted among devices 120 may require stringent delay requirements similar to those required by ultra-low latency links (ULLL). For example, audio data may require ultra-low latency links to meet the quality of service (QoS) associated with audio data or conversational audio data in real time. It is desired to transmit audio and ranging signals in one packet to reduce power consumption and communication overhead.

In some embodiments, one device may transmit audio data and a ranging signal in a multicast transmission to multiple devices. For example, device 120-1 may send the audio data associated with user 110-1 to devices 120-2, 3, and 4 in one transmission. For example, the transmission power may be determined by the weakest channel condition requiring the highest power.

In some instances, the transmitter of a multicast transmission may determine the transmission configuration based on one or more channel conditions between the transmitter and the receivers. For example, in a multicast transmission from device 120-1 to devices 120-2, 3, and 4, the transmission configuration may be based on channel conditions 145, e.g., channel conditions between device 120-1 and devices 120-2, 3, and 4.

In some embodiments, one device may transmit audio data and ranging signal(s) in a unicast transmission to one device. For example, device 120-1 may send its own audio data to device 120-2. During the transmission from device 120-1 to 120-2, devices 120-3 and 4 may not need to monitor the channel or attempt to receive or decode information. Device 120-2 may transmit its own audio data, the audio data it received from device 120-1 in previous transmission, and one or more ranging signals to device 120-3. During the transmission from device 120-2 to device 120-3, devices 120-1 and 4 may not need to monitor the channel or attempt to receive or decode information.

In some instances, the transmission of a unicast or one-to-one transmission may determine the transmission configuration based on the channel conditions between the transmitter and the receiver. For example, in a multicast transmission from device 120-1 to devices 120-2, the transmission configuration may be based on channel conditions 145-12. Channel condition 145-12 may determine the transmission power.

It is desired that the power consumption be reduced to increase battery life and improve the quality of experience for users.

### II. Frame Structure

A frame may be referred to as the unit of digital data transmission. The frame structure may repeat in time-division multiplexing such that each transmission may include a packet with the same or similar frame structure. An instance of a frame structure may be referred to as a packet. A frame may be divided into segments or components. Each segment of a frame may be assigned a functionality, e.g.: frame control that may provide information such as content of the frame or duration or length of the frame; an address field containing addresses of the source, or routing information such as address of next hub or final destination; sequence number that may provide order of the packet; reference signal, which may be responsible of channel measurements, synchronization, or ranging; and data, which may include the application data, system control data, and other information such as transmission configuration information, or checksum sequence for quick error detection.

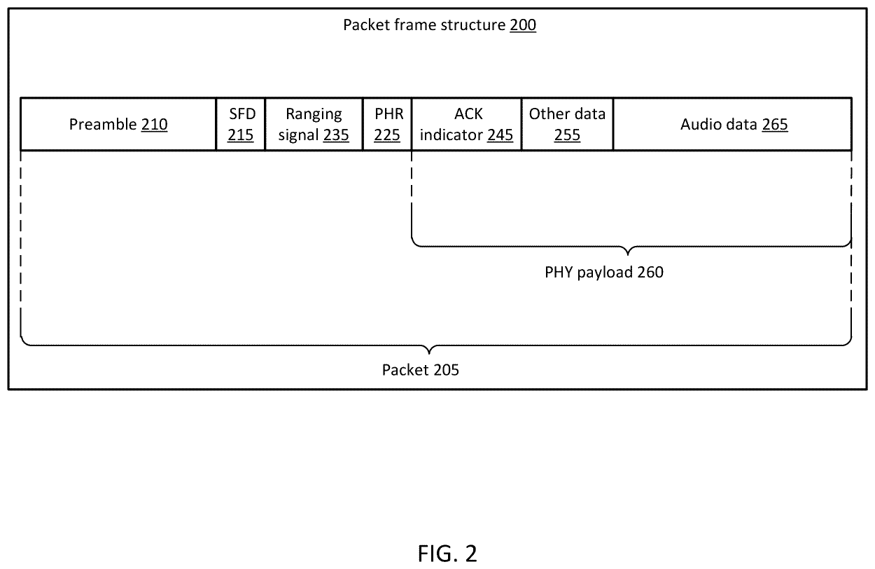

FIG. 2 illustrates a packet frame structure 200 in accordance with some embodiments. Packet frame structure 200 is an example of different components together forming a packet for carrying ultra-low latency data and one or more ranging signals. Packet frame structure 200 may include preamble 210, the start of the frame (SFD) field 215, the physical layer header (PHR) field 225, and physical layer (PHY) payload 260. The signals and symbols included in preamble 210, SFD 215, PHR 225, and PHY payload 260 may be referred to as packet 205.

Preamble 210, the synchronization or sync field, may be transmitted at the beginning of the frame. Preamble 210 may be used for accurate transmission and reception of data. One purpose of the preamble 210 may be to ensure synchronization between the transmitter and receiver. Preamble 210 may contain a predefined pattern of pulses or symbols. The pattern may repeat a specific number of times. The receiver may use the preamble and knowledge of the specific patterns of symbols and pulses to perform a synchronization procedure. Preamble 210 may provide time synchronization, which may determine the sampling time of the received signal. In addition, the receiver may obtain parameters such as timing and frequency offset, slot synchronization and timing, and interpacket gap.

SFD field 215 may provide a timestamp, which may be used for ranging. SFD field 215 may have different length, e.g., 4, 8, 16, 32, or 64 symbols. Symbols in SFD field 215 may be binary or ternary codes. Different lengths or coding may provide flexibility to adjust the SFD 215 to different data rates or coding and modulation schemes.

PHR field 225 may provide information to the receiver about the PHY payload 260 transmitted by the transmitter. For example, PHR field 225 may include symbols, e.g., bits, to indicate the data rate of PHY payload 260. PHR field 225 may include symbols, e.g., bits, to indicate the length of PHY payload 260. The length of PHY payload 260 may be expressed in the number of bytes or octets. PHR field 225 may include symbols, e.g., bits, to indicate whether the present frame is used for ranging, not for ranging, or for joint transmission of one or more ranging signals and audio data. For example, bits 9 and 10 of the PHR 225 may be used to determine the ranging scheme.

Ranging signal 235 may be used to perform a ranging operation. Ranging signal 235 may be narrowband or wideband. A narrowband signal may be a longer signal in the time domain in comparison to a wideband signal. Ranging signal 235 may be an ultra-wideband signal with a very small time duration.

In some instances, the ranging procedure may be a two-way exchange. User A may send a packet, e.g., packet 205, including a ranging signal to user B. The ranging signal in the packet may be referred to as a “ping” signal or simply ping. In response to the ping, user B may send a packet, including a ranging signal, to user A. The ranging signal sent from user B to user A in response to the ping may be called a “pong” signal or simply pong. The ranging procedure may be extended to a three-way exchange. In a three-way exchange, after user A sends a ping signal to user B and receives a pong signal from user B, use A may send a second ping signal to user B. In two-way or three-way, users may use the ranging signals to estimate time of flight (ToF) or angle of arrival (AoA) based on the received signals and associated measurements.

PHY payload 260 may include acknowledgement (ACK) indicator 245. ACK indicator 245 may indicate whether previously received data were successfully received. In some instances, if the data was not successfully received, the transmitter may retransmit the data. In some implementations, the original or initial transmission, transmission of ACK indicator, and retransmission may be referred to as automatic repeat request (ARQ) or hybrid-ARQ (HARQ) process.

In some instances, a receiver may only send ACK indicator 245 to the transmitter only when the receiver fails to successfully receive the original transmission. A receiver may successfully receive a transmission if the receiver successfully decodes and retrieves information from the transmitted packet.

In some instances, ACK indicator 245 may include indications associated with more than one transmission. For example, user A may receive data packets from users B, C, and D. User A may broadcast a packet that is received by users B, C, and D, and the ACK indicator of the broadcasted packet may include ACK corresponding to packets previously received from users B, C, and D.

PHY payload 260 may include audio data 265. Audio data 265 may be associated with a real-time conversation or audio streaming. In some embodiments, audio data 265 may include audio data associated with a single user or device. In other embodiments, audio data 265 may include audio data associated with more than one user or device.

PHY payload 260 may include other data 255. Other data 255 may include non-audio data. In some instances, audio data 255 may include ranging data, e.g., measured AoA, ToA, timestamps, or other ranging information or measurements. In some instances, other data 255 may have ultra-low latency requirements, e.g., real-time gaming or video streaming data.

In some instances, each component in packet 205 may be representative of a radio frequency (RF) waveform. Packet 205 may be formed by sequentially transmitting each waveform one after another.

In some instances, components of packet 200 are represented in the baseband. All or some subsets of the components may be used to create an RF waveform for transmission.

### III. Ping-Pong-Ping or 3-Way Ranging

Ranging may be the process of determining a device's location or the distance between two devices. Identifying a device's location or relative direction may require measuring parameters such as angle of arrival (AoA) or angle of departure (AoD). In some instances, determining AoA or AoD may require multiple antennas at the transmitter or receiver and the implementation of multi-input-multi-output (MIMO) techniques.

Determining the distance may require measuring the time a signal travels from one device to another and back, e.g., round-trip time (RTT) or time of flight (ToF). Knowing the speed at which the signal travels and the RTT, the distance between the two devices can be measured.

In some instances, a two-way ranging (TWR) may be used to determine the time of flight (ToF) or RTT between two devices. In TWR, an initiator may transmit a message to a responder, a ranging request, and record a timestamp associated with the transmission. The request message may be called a ping signal or simply ping. The initiator may receive a response from the responder and record a timestamp. The response signal may be called a pong signal or simply pong. The initiator may calculate the RTT (or, equivalently, ToF) based on the timestamps.

A three-way exchange ranging may be an extension of TWR.

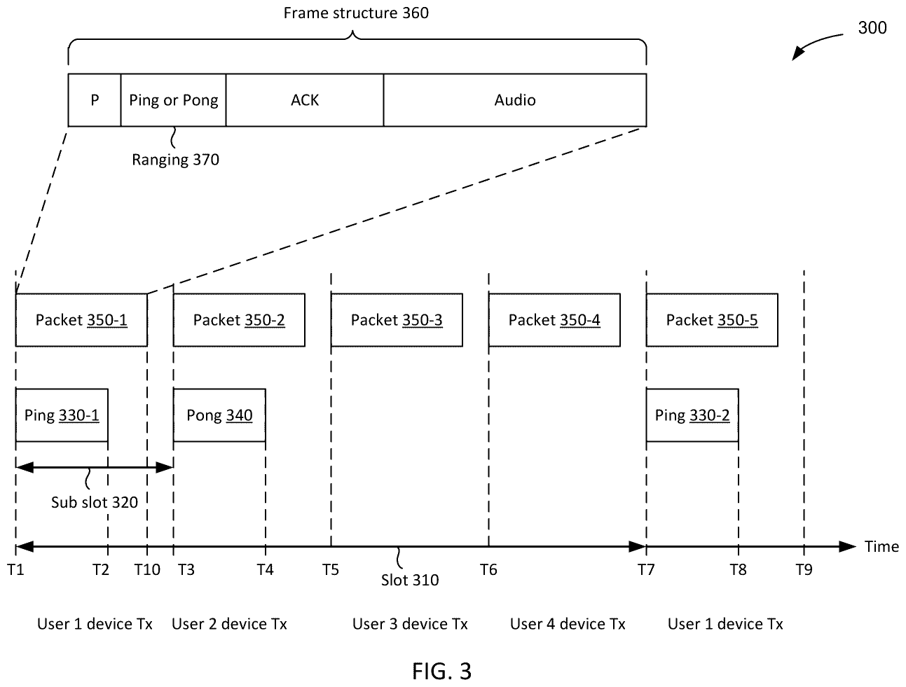

FIG. 3 illustrates ranging signaling 300 in accordance with some embodiments. Ranging signaling 300 may be an example of a 3-way exchange ranging signaling. The ranging diagram includes transmissions of packets 350. Each transmitted packet, e.g., packets 350-1, 2, 3, 4, and 5, may have a frame structure 360. Frame structure 350 may be an example of frame structure 200 in FIG. 2. Frame structure 360 may include a preamble, ACK, audio data, or ranging signal 370. Ping(s) 330 and pong 340 signals are intended to represent the ranging functionality provided by the packets and may not be separately transmitted packets. For example, ping 330-1 may be associated with the ranging component of packet 350-1.

Four users are transmitting in a round-robin manner in slot 310, and the pattern may repeat in subsequent slots. Each user is transmitting within a sub-slot. For example, user 1 device may transmit packet 350-1 in sub-slot 320. Slot 310 has a duration of T7-T1, and sub-slot 320 has a duration of T3-T1. User 2 device may transmit in the sub-slot between T3 and T5, having a duration of T5-T3. User 3 device may transmit in the sub-slot between T5 and T6, having a duration of T6-T5. User 4 device may transmit in the sub-slot between T6 and T7, having a duration of T7-T6. In the subsequent slot, user 1 device again transmits in the first sub-slot between T7 and T9, having a duration of T9-T7.

When a user transmits in a slot, one or more other devices may receive the transmitted signal. For example, when user 1 device transmits in the first slot, one or more of user 2, 3, and 4 devices may receive the transmitted packet by user 1. In FIG. 3, it is assumed that user 2 device may receive transmissions by user 1 device and user 1 receives transmissions by user 2.

In one example, sub-slots within the slot have the same duration, e.g., T3-T1 and T5-T3 and T6-T5 and T7-T6 have the same value. The value of a sub-slot may be less than 5 ms, e.g., 0.5 ms, 1 ms, or 2 ms. In one example, sub-slots in different slots may have the same duration, e.g., T3-1 and T9-T7 may have the same value.

Ping 330-1 may represent the ranging component of packet 350-1, pong 340 may represent the ranging component of packet 350-2, and ping 330-2 may represent the ranging component of packet 350-5. In some instances, the receiver may detect and receive the ranging component of a packet before completing the reception of the entire packet. For example, Packet 350-1 transmission completes at T10, but the receiver may receive the ranging component of packet 350-1 at T2.

In some embodiments, a 3-way exchange ranging may be implemented. User 1 device at T1 may send packet 350-1. Packet 350-1 may include a ping signal, requesting user 2 device for ranging. Packet 350-1 may also include a timestamp associated with T1. User 2 device may receive the ping 330-1 associated with packet 350-1 at T2. User 2 device may process the received request, process the response, and transmit the response in packet 350-2 at T3. Packet 350-2 may include timestamps associated with T2 or T3. User 1 device may receive pong 340 associated with packet 350-2 at T4. User 1 device, having the information associated with T1 , T2, T3, or T4, may calculate the ToF (or RTT). Using ToF and propagation speed of the transmitted signals, user 1 device may calculate the distance between user 1 device and user 2 device, D1.

Packet 350-2 may also include a ranging request to user 1. In response to packet 350-2 or pong 340, the user 1 device at T7 may send packet 350-5. Packet 350-5 may include timestamps associated with T4, T5, or T7. User 2 device may receive ping 330-2 associated with packet 350-5 at T8. The user 2 device with the information associated with T3, T4, T5, or T7 may calculate the ToF. Using ToF and propagation speed of the transmitted signals, the user 2 device may calculate the distance between the user 2 device and the user 2 device, D2.

User 2 device may receive calculated D1 from user 1 device. For example, the user 2 device may receive calculated D1 from the user 1 device in the packet 350-5 PHY payload component. User 2 may use D1 and D2 to obtain a more accurate estimate of the distance between user 1 and user 2. For example, user 2 device may calculate D3 as the average of D1 and D2.

Similarly, user 1 device may receive calculated D2 from user 2 device. For example, the user 1 device may receive calculated D2 from the user 2 device in the PHY component of a packet. User 1 may use D1 and D2 to obtain a more accurate estimate of the distance between user 1 and user 2. For example, user 2 device may calculate D3 as the average of D1 and D2.

### IV Ultra-Low Latency Link for Audio Data and Ranging

In some instances, the ranging signals are short signals in the time domain. However, the transmission of ranging signals may require the transmission of overheads, such as a preamble. Live audio data may be transmitted in small packets with stringent latency requirements. In some embodiments, audio data and ranging signals are transmitted in the same transmission, e.g., the same packet. Joint transmission of ranging signal and audio data may reduce the transmitted overhead, e.g., preamble. It may also provide surround sound or 3D features to the audio.

An example use case may be in crowded restaurants, bars, airports, concerts, construction sites, theme parks, group sports, airplanes, or public or private gatherings. A group of users may form a local network or coordinated set that may talk to each other through their devices, e.g., earbuds with directionality. Due to noise, barriers (e.g., helmets, walls, glasses), or distance, the acoustic SNR may be low between some users in the coordinated set. Low acoustic SNR may be addressed by active or passive noise cancelation or wirelessly relaying of the audio data, including boosting and beamforming.

The acoustic SNR may measure how clearly the loudest sound (signal) stands out from quieter background sounds (noise). Signal and noise may be measured at the microphone receiving the signal. The noise may be associated with external ambient sounds or may be associated with the electronics in the microphone or recorder circuitries.

In some embodiments, the audio data may be transmitted periodically in a round-robin fashion. Periodic round-robin transmission may allow multiple users to talk simultaneously and may not require one user to talk and other users to listen.

In some embodiments, directionality between users may be obtained by utilizing ranging signals, e.g., UWB signals, and by embedding the ranging signals into the packet carrying audio data. The embedded ranging signal may have a different cadence than the audio data packet. The ranges between pairs may be used to find the topology and direction among users. The directionality may be derived from the distances among the users, e.g., using techniques such as triangulation. Derived directionality may be used to implement spatial audio for each user-to-user in the network. In some instances, when ranging is not needed, ranging components may be removed from the packet. The intermediate values for ranging may be exchanged among users by piggybacking to the payload with audio data or other data in the PHY payload.

The ranging signal may provide spatialization per peer, e.g., each device may determine an angle and volume associated with every other device in the coordinated set. The spatialization per peer may result in effect as if noise is suppressed for all the participants. Directionality may enable the human interface (HI) to have features such as parallel conversations, selecting subgroups based on where the devices are pointed, or muting some conversations.

In some examples, there may be purely passive listeners in the network. A centralized or distributed scheduler may provide users with a transmission or reception schedule. When a user joins the conversation as a speaker or leaves the group, the scheduler may adjust the transmission or reception schedule accordingly.

### A. Multicasting

Multicasting may be a method of group communication where data transmitted from one user is addressed to a group of destinations, e.g., user devices. Multicasting may be from one transmitting device to many receiving devices, e.g., one-to-many. Multicasting may be from many transmitting devices to many receiving devices, e.g., many-to-many. When multicasting is combined with round-robin scheduling, it may indicate that there may be a multicast transmission at each round of the round-robin schedule.

In some embodiments, there may be a single transmitter at each round of the round-robin schedule, sending data in a multicast transmission to one or more receiving devices.

In some embodiments, each user may determine a schedule. The schedule may be provided through a centralized scheduler or computed through a distributed scheduling algorithm on the device. The schedule may include a transmission schedule and a reception schedule. The transmission schedule may indicate the time slot or sub-slot at which the device may transmit a packet. The transmission schedule may also indicate one or more destination devices. The reception schedule may include the time slot or sub-slot at which the device may receive a packet. The reception schedule may also indicate the transmitting device that sends the packet.

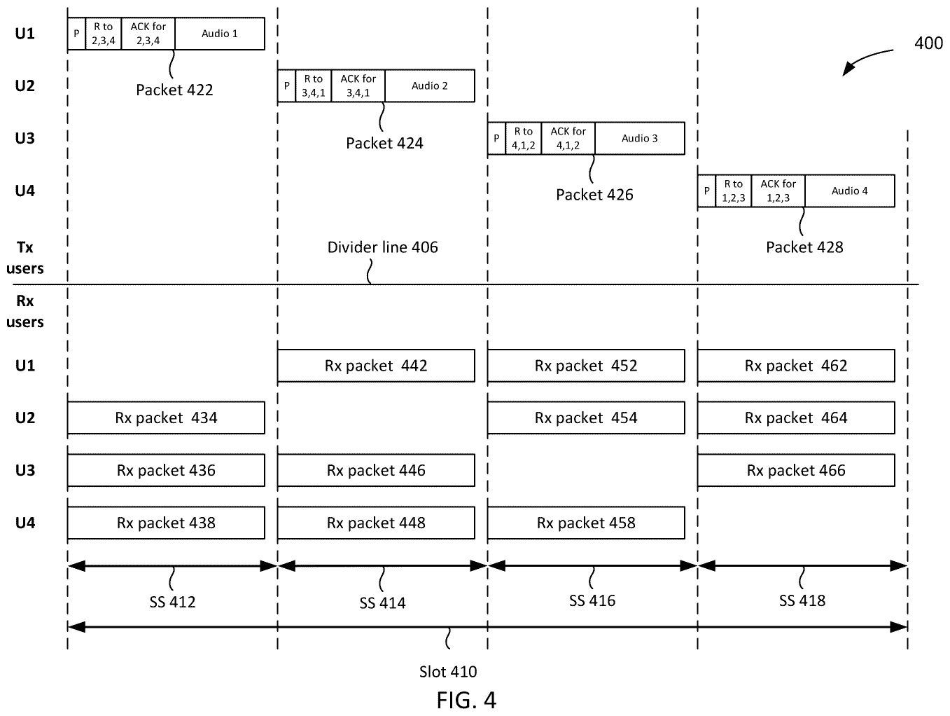

FIG. 4 illustrates an audio and ranging signaling diagram 400 in accordance with some embodiments. Audio and ranging signaling diagram 400 is an example of multicasting audio data and ranging signal in a round-robin fashion. The example considers four devices associated with users 1, 2, 3, and 4. Users are scheduled in a round-robin fashion.

Slot 410 may be divided into as many sub-slots as there are active transmitters. For example, with four active transmitters, slot 410 may be divided into four sub-slots 412, 414, 416, and 418. Diagram 400 is divided into two parts by the divider line 406. The portion of diagram 400 above the divider line 406 illustrates the transmissions associated with users at each sub-slot. The portion of diagram 400 below the diver line 406 illustrates the receptions associated with users at each sub-slot.

At sub-slot 412, user 1 device may transmit packet 422. The transmission schedule at user 1 may indicate that user 1 device is scheduled to transmit packet 422 to user devices 2, 3, and 4, which is sub-slot 412. User 1 device may multicast packet 422 to user devices 2, 3, and 4. Packet 422 may include a preamble component, ranging signals to user devices 2, 3, and 4, ACK messages to user devices 2, 3, and 4, and audio data associated with user 1 or user 1 device. The reception scheduler at user 1 device may indicate that user 1 device is not scheduled to receive any packet in sub-slot 412.

The reception scheduler at users 2, 3, and 4 devices may indicate that they are receiving a packet in sub-slot 412. The scheduler may indicate that the packet is transmitted by user 1 device. For example, at sub-slot 412, user 2 device may receive packet 434 associated with transmitted packet 422, user 3 device may receive packet 436 associated with transmitted packet 422, and user 4 device may receive packet 438 associated with transmitted packet 422.

In multicast transmission, user 1 device may perform a single transmission of packet 422. The wireless signal carrying packet 422 to user 2, 3, and 4 devices may pass through different wireless channels. Each channel may have different characteristics. As such, the received packets 434, 436, and 438 at corresponding user devices 2, 3, and 4 may have different attributes, e.g., have a different SNR. User 1 device may need to adjust its transmission configuration, e.g., transmission power or data rate, based on the channel conditions associated with each of the receiving devices. For example, user 1 device may obtain channel conditions between user 1 device and each of the user 2, 3, and 4 devices and adjust its transmission power or rate based on the channel conditions. If the user 1 device does not have all the channel conditions, the user 1 device may determine the transmission power or rate based on the available channel conditions.

In one example, the transmitter of a multicast packet may determine the transmission power or rate based on the worst channel condition. The transmission power based on the worst channel condition may be larger than the transmission power based on other channel conditions. Good or bad channel condition may refer to the quality of the link. Good channel condition may refer to a situation where the signal strength at the receiver is strong, and the noise or interference level is low. Bad channel conditions may occur when the signal strength at the receiver is weak or the level of interference or noise is high. The worst channel condition may refer to the channel having the smallest SNR at the receiver, and the best channel condition may be the channel with the highest SNR at the receiver.

At sub-slot 414, user 2 device may be scheduled to multicast packet 424 to user 1, 3, or 4 devices. User 1 may receive packet 442, user 3 device may receive packet 446, and user 4 device may receive packet 448, associated with the transmission of packet 424. Packet 424 may include ranging signal or signals directed to devices 1, 3, or 4. Packet 424 may include ACK associated with packets user 2 device has received previously from user 1, 3, or 4 devices. Packet 424 may include audio data. The audio data may be associated with the user 2 or user 2 device.

At sub-slot 416, user 3 device may be scheduled to multicast packet 426 to user 1, 2, or 4 devices. User 1 may receive packet 452, user 2 device may receive packet 454, and user 4 device may receive packet 458, associated with the transmission of packet 426. Packet 426 may include ranging signal or signals directed to devices 1, 2, or 4. Packet 424 may include ACK associated with packets user 3 device has received previously from user 1, 2, or 4 devices. Packet 426 may include audio data. The audio data may be associated with the user 3 or user 3 device.

At sub-slot 418, user 4 device may be scheduled to multicast packet 428 to user 1, 2, or 3 devices. User 1 may receive packet 462, user 2 device may receive packet 464, and user 3 device may receive packet 466, associated with the transmission of packet 428. Packet 428 may include ranging signal or signals directed to devices 1, 2, or 3. Packet 428 may include ACK associated with packets user 4 device has received previously from user 1, 2, or 3 devices. Packet 428 may include audio data. The audio data may be associated with the user 4 or user 4 device.

In one embodiment, a transmitting device may multicast to all the other devices in the coordinated set. The multicast packet may include a scrambled timestamp sequence (STS). STS may be used to provide additional integrity or accuracy for ranging measurements. The packet may include an audio payload, timing stamps for each packet it listened to most recently from all other devices, or ACL for the most recent packets it received.

The ping-pong-ping, 3-way ranging exchange may be non-uniformly distributed. For example, packet 422 may include the ping sent from user 1 device to user 2 device, and packet 424 may include the pong response sent by user 2 device to user 1. However, user 1 device may not send the subsequent ping until the scheduled transmission of user 1 device in the subsequent slot.

In one embodiment, all users may perform time of arrival or time of flight calculations between pairs and report the TOA, TOF, or the computed distance.

In one example, the latency, e.g., the time between two consecutive transmissions by the same user device, is associated with the duration of one slot. The slot duration may be fixed, e.g., 1 ms. The time duration for each sub-slot may be based on the number of active transmitters. For example, if there are 4 active transmitters, the duration of sub-slot may be 0.25 ms.

### B. Daisy Chaining

To reduce the power consumption associated with multicasting, in one example, the transmitted packet is sent to one receiver at each sub-slot. The transmitter may adjust transmission configuration, e.g., transmit power or rate, based on one channel condition associated with the receiver. Moreover, other devices that do not participate in transmission or reception do not need to listen to or monitor the channel.

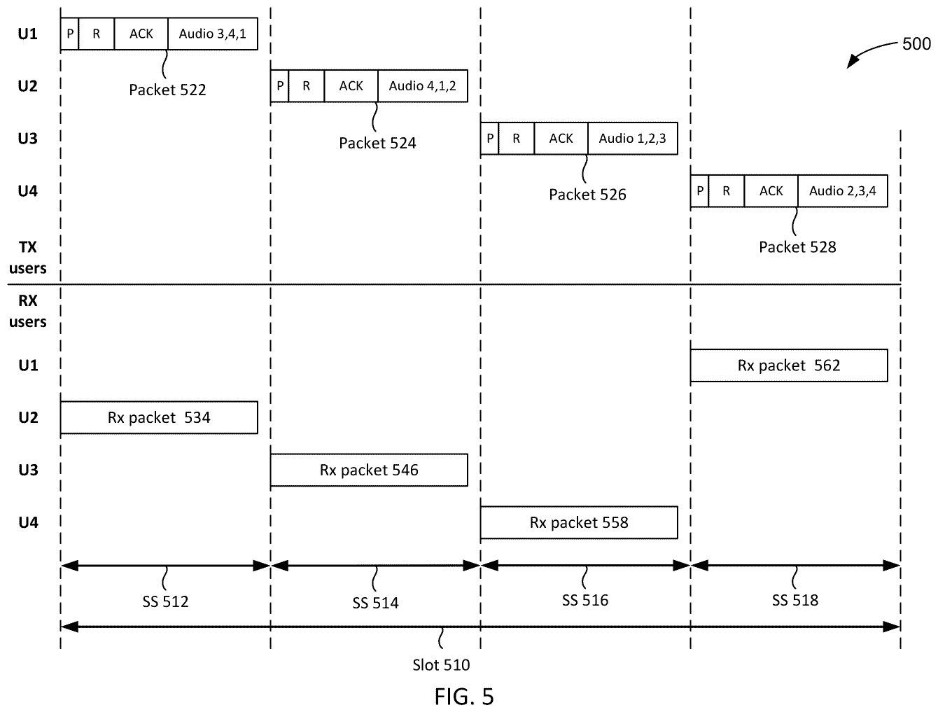

FIG. 5 illustrates an audio and ranging signaling diagram 500 in accordance with some embodiments. Audio and ranging signaling diagram 500 is an example of a daisy chain scheme. In a daisy chain scheme at each sub-slot, one transmitter and one receiver are scheduled. The transmitter may send a packet that includes ranging signals and payload. The packet is received by the scheduled receiver. In one example, other devices may listen and receive the ranging signals.

Ranging signaling diagram 500 illustrates the signaling diagram for a system with four active transmitters. However, the diagram can be extended to any number of active transmitters and receivers. The diagram shows one slot, slot 510. Slot 510 is divided among the active transmitters, e.g., devices 1, 2, 3, and 4. Each sub-slot 512, 514, 516, and 518 is corresponding to one round in a round-robin schedule. In one example, duration slot 510 may be determined based on the quality of the service or latency requirement. Slot 510 duration may be 1 ms. Time resources in a slot are then divided among the active users; e.g., 1 ms is divided among four active users. Thus, each sub-slot 512-518 may be 0.25 ms.

The transmission schedule may indicate that user device 1 may transmit packet 522 to user 2 device at sub-slot 512. User 1 device may obtain the channel condition associated with user 2 device. User device 1 may determine transmission configuration, such as transmit power or data rate, based on the channel condition. The reception schedule at user 2 device may indicate that user 2 may receive a packet, e.g., packet 534, at sub-slot 512.

Packet 522 may include a preamble as described above. The ranging component of packet 522 may include a ranging signal for ranging operation with the user 2 device. The ranging component of packet 522 may include ranging signals for ranging operation with other user devices, e.g., user 3 or 4 devices. Packet 522 may include ACK corresponding to one or more packets received by user 1 device. Packet 522 may include audio data. The audio data of packet 522 may include audio data associated with one or more user devices. For example, audio data of packet 522 may include audio data associated with user 3, 4, or 1 devices. User 1 device may receive the audio data associated with user 3 or 4 devices through previously received packets.

The PHY payload of packet 522 may include ranging data. For example, PHY payload of packet 522 may include measured TOA, TOF, or estimated distances to other devices in the coordination set.

In one example, user 2 device may receive the ranging component of packet 522. In another example, one or more user devices, e.g., user 2, 3, or 4 devices, may receive the ranging component of packet 522.

The transmission schedule may indicate that user device 2 may transmit packet 524 to user 3 device at sub-slot 514. User 2 device may obtain the channel condition associated with user 3 device. User device 2 may determine transmission configuration, such as transmit power or data rate, based on the channel condition. The reception schedule at user 3 device may indicate that user 3 may receive a packet, e.g., packet 546, at sub-slot 514.

Packet 524 may include a preamble as described above. The ranging component of packet 524 may include a ranging signal for ranging operation with the user 3 device. The ranging component of packet 524 may include ranging signals for ranging operation with other user devices, e.g., user 4 or 1 devices. Packet 524 may include ACK corresponding to one or more packets received by user 2 device. Packet 524 may include audio data. The audio data of packet 524 may include audio data associated with one or more user devices. For example, audio data of packet 524 may include audio data associated with user 4, 1, or 2 devices. User 2 device may receive the audio data associated with user 4 or 1 devices through previously received packets, e.g., packet 522.

The PHY payload of packet 524 may include ranging data. For example, PHY payload of packet 524 may include measured TOA, TOF, or estimated distances to other devices in the coordination set.

In one example, user 3 device may receive the ranging component of packet 524. In another example, one or more user devices, e.g., user 3, 4, or 1 devices, may receive the ranging component of packet 524.

The transmission schedule may indicate that user device 3 may transmit packet 526 to user 4 device at sub-slot 516. User 3 device may obtain the channel condition associated with user 4 device. User device 3 may determine transmission configuration, such as transmit power or data rate, based on the channel condition. The reception schedule at user 4 device may indicate that user 4 may receive a packet, e.g., packet 558, at sub-slot 516.

Packet 526 may include a preamble as described above. The ranging component of packet 526 may include a ranging signal for ranging operation with the user 4 device. The ranging component of packet 526 may include ranging signals for ranging operation with other user devices, e.g., user 1 or 2 devices. Packet 526 may include ACK corresponding to one or more packets received by user 3 device. Packet 526 may include audio data. The audio data of packet 526 may include audio data associated with one or more user devices. For example, audio data of packet 526 may include audio data associated with user 1, 2, or 3 devices. User 3 device may receive the audio data associated with user 1 or 2 devices through previously received packets, e.g., packet 524.

The PHY payload of packet 526 may include ranging data. For example, PHY payload of packet 526 may include measured TOA, TOF, or estimated distances to other devices in the coordination set.

In one example, user 4 device may receive the ranging component of packet 526. In another example, one or more user devices, e.g., user 1, 2, or 4 devices, may receive the ranging component of packet 526.

The transmission schedule may indicate that user device 4 may transmit packet 528 to user 1 device at sub-slot 518. User 4 device may obtain the channel condition associated with user 1 device. User device 4 may determine transmission configuration, such as transmit power or data rate, based on the channel condition. The reception schedule at user 1 device may indicate that user 1 may receive a packet, e.g., packet 562, at sub-slot 518.

Packet 528 may include a preamble as described above. The ranging component of packet 528 may include a ranging signal for ranging operation with the user 1 device. The ranging component of packet 528 may include ranging signals for ranging operation with other user devices, e.g., user 2 or 3 devices. Packet 528 may include ACK corresponding to one or more packets received by user 34 device. Packet 528 may include audio data. The audio data of packet 528 may include audio data associated with one or more user devices. For example, audio data of packet 528 may include audio data associated with user 2, 3, or 4 devices. User 4 device may receive the audio data associated with user 2 or 3 devices through previously received packets, e.g., packet 526.

The PHY payload of packet 528 may include ranging data. For example, PHY payload of packet 528 may include measured TOA, TOF, or estimated distances to other devices in the coordination set.

In one example, user 1 device may receive the ranging component of packet 528. In another example, one or more user devices, e.g., user 1, 2, or 3 devices, may receive the ranging component of packet 528.

In some instances, every device may need to listen to other devices once in every slot. The transmission configuration, such as power or rate control, may depend only on one channel condition. By selecting the transmitter-receiver pairs that are closer to each other, lower power consumption or higher data rate may be achieved. In another example, devices may be paired based on the channel condition between them, e.g., received SNR.

### V. Retransmission

Retransmission may be referred to as an automatic repeat request (ARQ) and may involve resending a packet that the receiver has not received successfully. In some instances, the sender may automatically retransmit the packet. For example, if the sender does not receive an acknowledgment or a negative acknowledgment associated with a transmitted packet, the sender may resend the packet.

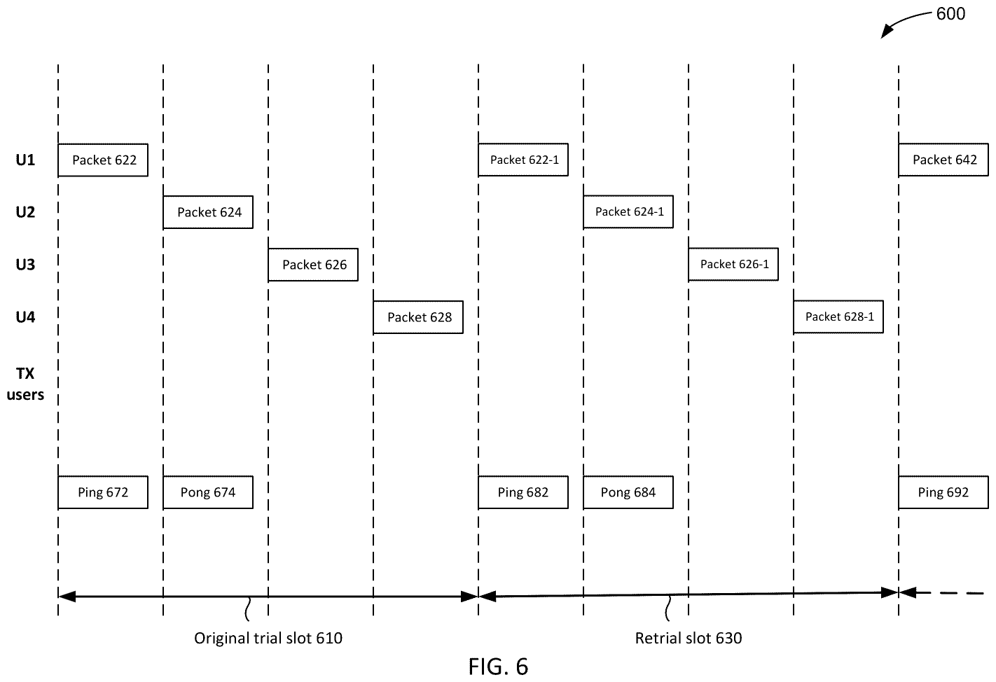

FIG. 6. illustrates a retransmission diagram 600 in accordance with some embodiments. Retransmission diagram 600 is an example of a retransmission scheme in which one slot, e.g., slot 610, is allocated for transmission, and another slot, e.g., slot 630, is allocated for retransmission. In one example, the retransmission slot may immediately follow the transmission slot. In another example, there may be one or more slots between a transmission slot and its corresponding retransmission slot.

At slot 610, user devices 1, 2, 3, and 4 may transmit the corresponding 622, 624, 626, and 628 packets. In one example, if one or more of the transmitted packets 622-628 is unsuccessfully received, a retrial slot 630 may be scheduled. At retrial slot 630, user devices 1, 2, 3, and 4 may again transmit the corresponding packets 622-1, 624-1, 626-1, and 628-1 once again. Packet 622-1 in retrial slot 630 may contain the same payload, ACK, or ranging as packet 622 in original trial slot 610. Some fields in packet 622-1 of retrial slot 630 may be updated, e.g., an indication of retransmission or a different pattern in the preamble. Similarly, some fields in packets 624-1, 626-1, or 628-1 may be different than their corresponding original trial packets 624, 626, and 628.

If the retransmissions at retrial slot 630 are received successfully, the devices may resume transmission of new data in the next slot. For example, packet 642 in the slot following the retiral slot 630 may contain new audio data.

In one instance, if a retransmitted packet is not received successfully, another retrial slot for retransmission may be scheduled. In another instance, if a retransmitted packet is not received successfully, that packet may be dropped, and no retransmission for a retransmitted packet may be scheduled.

The 3-way ranging exchange between user 1 device and user 2 device is illustrated. Packet 622 may include a ranging component acting as ping 672 to user 2 device. User 2 device may send packet 624, including ranging components acting as pong 674, to user 1. Similarly, the ranging components in the retransmitted packets 622-1 and 624-1 may correspond to ping 682 and pong 684. In the subsequent slot, the ranging component of packet 642 may be ping 692 to user device 2.

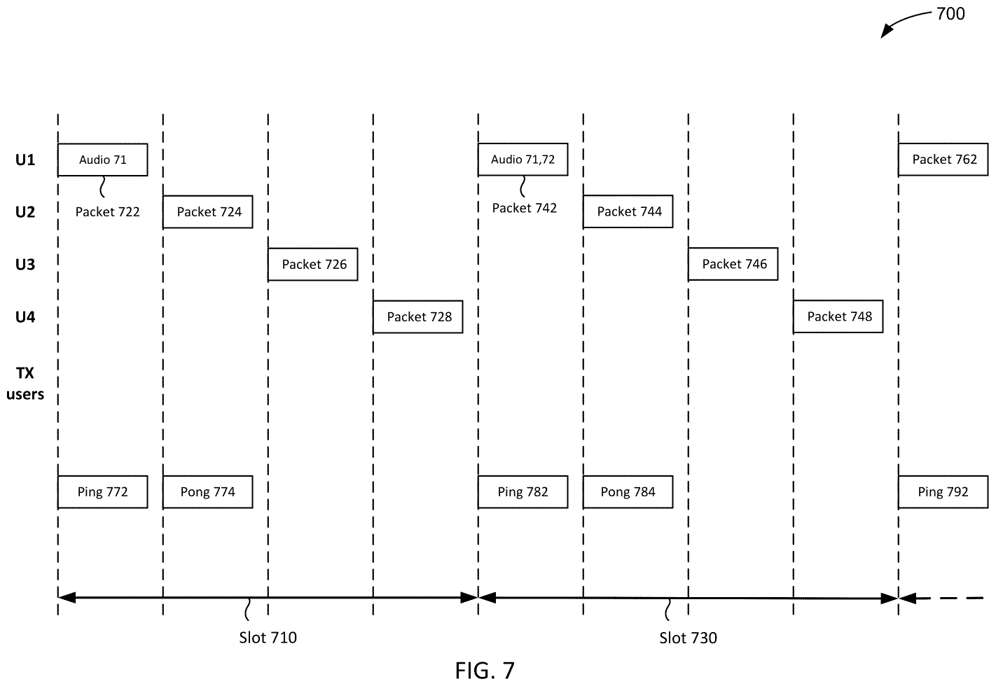

FIG. 7. illustrates a retransmission diagram in accordance with some embodiments. Retransmission diagram 700 is an example of a retransmission scheme in which one slot, e.g., slot 710, is allocated for original transmission, and another slot, e.g., slot 730, is allocated for retransmission or retrial. In one example, the retransmission slot may immediately follow the transmission slot. In another example, there may be one or more slots between a transmission slot and its corresponding retransmission slot.

At slot 710, user devices 1, 2, 3, and 4 may transmit the corresponding 722, 724, 726, and 728 packets. In one example, if one or more of the transmitted packets 722-728 is unsuccessfully received, a retrial slot 730 may be scheduled. At retrial slot 730, user devices 1, 2, 3, and 4 may transmit the corresponding packets 742, 744, 746, and 748.

The retrial packets may include the payload of the previous transmission as well as a new payload. For example, original packet 722 may include audio data 71. The retransmission packet 742 corresponding to packet 722 may include audio data 71, the previous transmission, and new audio data 72. Similarly, retransmission packet 744 may include the payload of packet 724 and a new payload, retransmission packet 746 may include the payload of packet 726 and a new payload, and packet 748 may include the payload of packet 728 and a new payload.

If the retransmissions at retrial slot 730 are received successfully, the devices may resume transmission of new data in the next slot. For example, packet 762 in the slot following the retiral slot 730 may contain new audio data.

In one instance, if a retransmitted packet is not received successfully, another retrial slot for retransmission may be scheduled. In another instance, if a retransmitted packet is not received successfully, that packet may be dropped, and no retransmission for a retransmitted packet may be scheduled.

The 3-way ranging exchange between user 1 device and user 2 device is illustrated. Packet 722 may include a ranging component acting as ping 772 to the user 2 device. User 2 device may send packet 724, including ranging components acting as pong 774, to user 1. Similarly, the ranging components in the retransmitted packets 742 and 744 may correspond to ping 782 and pong 784. In the subsequent slot, the ranging component of packet 762 may be ping 792 to user device 2.

### VI. Example Procedures

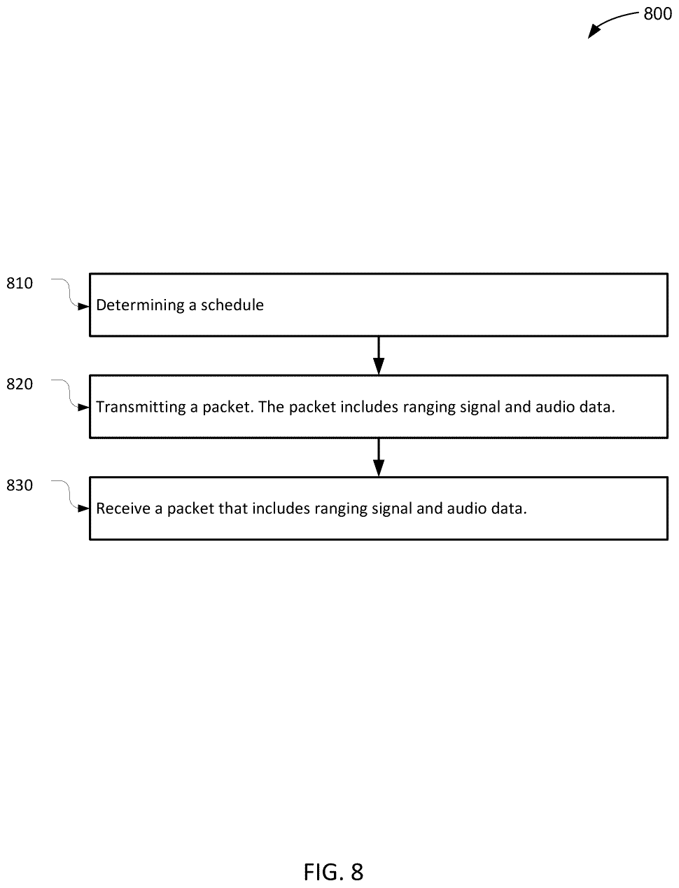

FIG. 8. illustrates a flow diagram 800 in accordance with some embodiments. The flow diagram 800 may be implemented by a controller in a user device (for example, controller 1100) or components therein, for example, processing subsystem 1110.

At 810, flow diagram 800 may include determining a schedule. The schedule may include a transmission schedule and a reception schedule.

At 820, flow diagram 800 may include transmitting a packet. The packet may be transmitted by a device to one or more other devices. The packet may include a ranging signal and audio data. The audio data may be associated with one or more user devices.

At 830, flow diagram 800 may include receiving a packet from another device. The packet may include ranging signal and audio data. The audio data may be associated with one or more user devices.

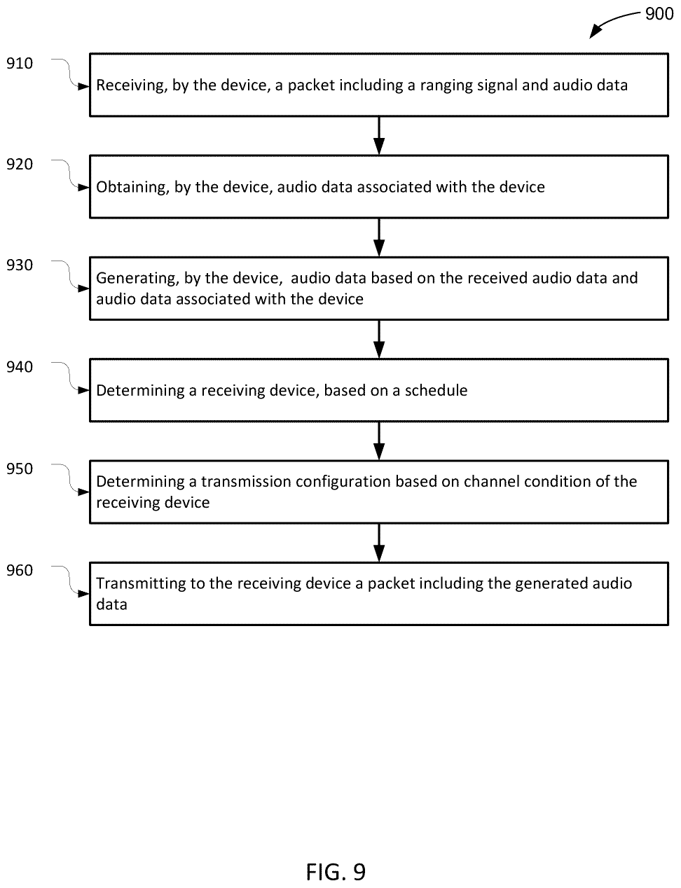

FIG. 9. illustrates a flow diagram 900 in accordance with some embodiments. Flow diagram 900 may be an example of a daisy chain transmission of audio data and ranging signals. The flow diagram 900 may be implemented by a controller in a user device (for example, controller 1100) or components therein, for example, processing subsystem 1110.

At 910, flow diagram 900 may include receiving a packet from another device. The packet may include a ranging signal and audio data. The audio data may include audio data associated with the transmitting device, or it may include audio data associated with other devices or users.

At 920, flow diagram 900 may include obtaining audio data associated with the device. The audio data may be from an audio streaming application or real-time conversation.

At 930, flow diagram 900 may include generating audio data based on the received audio data and obtained audio data in step 920. Generating audio data may include concatenation or jointly encoding the received audio data and the obtained audio data.

At 940, the flow diagram 900 may include determining a receiving device based on the schedule. The device may use the transmit schedule to determine the slot or sub-slot allocated for its transmission. The transmit schedule may also indicate the receiver or receivers.

At 950, flow diagram 900 may include determining a transmission configuration based on the channel condition of the receiving device. The device may previously send training or reference signals to the receiving device. The receiving device may have measured the channel condition and sent the channel condition to the device. In one example, the receiving device may use channel state information as an indicator for the channel condition. The device may use the received channel condition, e.g., the channel state information. The device may use the channel condition to determine the transmission configuration, e.g., transmit power or data rate.

At 960, flow diagram 900 may include transmitting to the receiving device a packet that includes the generated audio data.

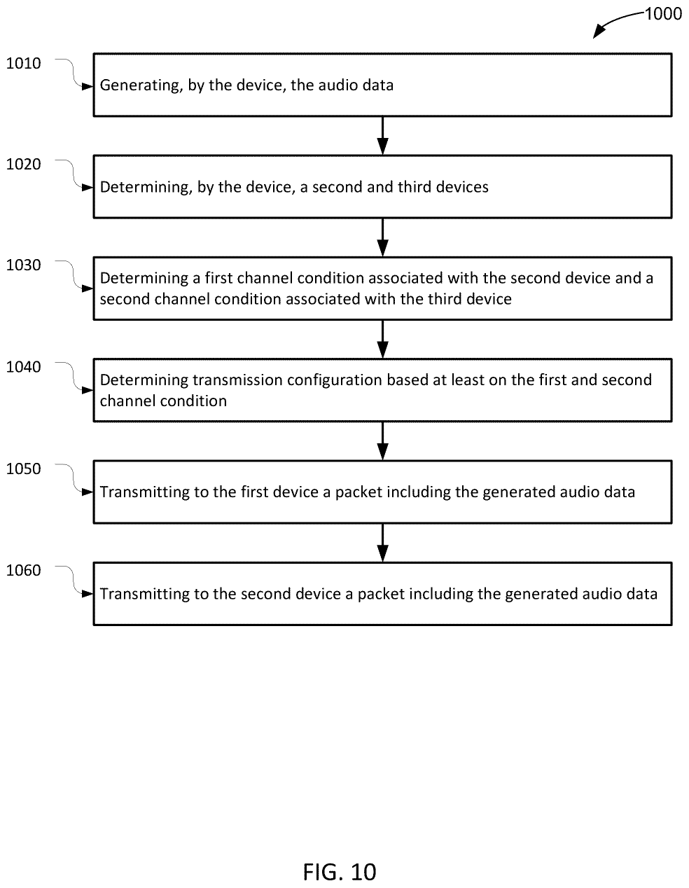

FIG. 10. illustrates a flow diagram 1000 in accordance with some embodiments. Flow diagram 1000 may be an example of multicast transmission of audio data and ranging signals. The flow diagram 900 may be implemented by a controller in a user device (for example, controller 1100) or components therein, for example, processing subsystem 1110.

At 1010, flow diagram 1000 may include generating the audio data. The audio data may include the audio data associated with the device or the user of the device.

At 1020, flow diagram 1000 may include determining two receiving devices. The device may determine the two receiving devices based on the transmission schedule.

At 1030, flow diagram 1000 may include determining the channel condition associated with the first receiving device and the channel condition associated with the second receiving device.

At 1040, flow diagram 1000 may include determining the transmission configuration based on the channel conditions associated with the first and second receiving devices. The transmission configuration may include transmit power or data rate.

At 1050, flow diagram 1000 may include transmitting a packet to the first device, including the generated audio data. The device may apply the transmission configuration to the packet transmission to the first device.

At 106, flow diagram 1000 may include transmitting a packet to the second device, including the generated audio data. The device may apply the transmission configuration to the packet transmission to the first device.

### VII. Example Device

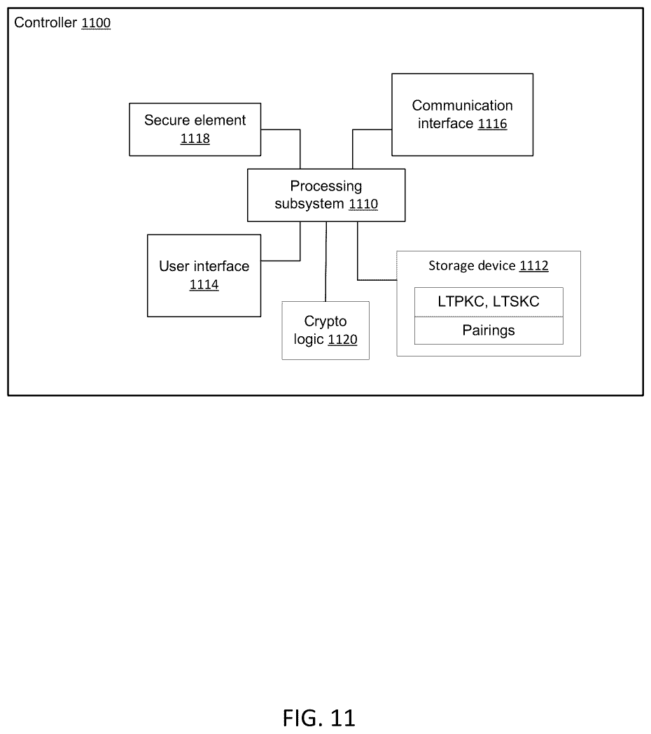

FIG. 11 illustrates a block diagram in accordance with some embodiments. FIG. 11 is a block diagram of a controller 1100 according to some embodiments. Controller 1100 may be included in a user device, a controller device, a resident device, a hub device, or an accessory device. Controller 1100 may implement any or all of the controller functions, behaviors, and capabilities described herein, and other functions, behaviors, and capabilities not expressly described.

For example, the application of the home automation system may be executed on the processing subsystem 1110, which may cause the communication interface 1116 to use the protocol and technology associated with the LAN for transmissions related to updating a primary location.

Controller 1100 may include processing subsystem 1110, storage device 1112, user interface 1114, communication interface 1116, secure element 1118, and cryptographic logic module 1120. Controller 1100 may also include other components (not explicitly shown), such as a battery, power controllers, and other components operable to provide various enhanced capabilities. In various embodiments, controller 1100 may be implemented in a desktop computer, laptop computer, tablet computer, smartphone, wearable computing device, or other systems having any desired form factor. Further, as noted above, controller 1100 may be implemented partly in a base station and partly in a mobile unit that communicates with the base station and provides a user interface.

Storage device 1112 may be implemented, e.g., using disk, flash memory, or any other non-transitory storage medium, or a combination of media, and may include volatile or nonvolatile media. In some embodiments, storage device 1112 may store one or more application or operating system programs to be executed by processing subsystem 1110, including computer-executable instructions or programs to implement any or all operations described herein as being performed by a controller. The storage device 1112 may include a non-transitory computer-readable medium to store computer-executable instruction or programs. The processing subsystem 1110 may include one or more processors configured to access the memory storage 1112. For example, storage device 1112 may store a uniform controller application that may read an accessory definition record and generate a graphical user interface for controlling the accessory based on the information therein. In some embodiments, portions (or all) of the controller functionality described herein may be implemented in operating system programs rather than applications. In some embodiments, storage device 1112 may also store apps designed for specific accessories or specific categories of accessories (e.g., an IP camera app to manage an IP camera accessory or a security app to interact with door lock accessories).

User interface 1114 may include input devices such as a touchpad, touch screen, scroll wheel, click wheel, dial, button, switch, keypad, microphone, or the like, as well as output devices such as a video screen, indicator lights, speakers, headphone jacks, or the like, together with supporting electronics (e.g., digital to analog or analog to digital converters, signal processors, or the like). A user may operate input devices of user interface 1114 to invoke the functionality of controller 1100 and may view or hear output from controller 1100 via output devices of user interface 1114.

Processing subsystem 1110 may be implemented as one or more integrated circuits, e.g., one or more single-core or multi-core microprocessors or microcontrollers, examples of which are known in the art. In operation, processing system 1110 may control the operation of controller 1100. In various embodiments, processing subsystem 1110 may execute programs in response to program code and maintain multiple concurrently executing programs or processes. At any given time, some or all of the program code to be executed may be resident in processing subsystem 1110 or in storage media such as storage device 1112.

Through suitable programming, processing subsystem 1110 may provide various functionality for controller 1100. For example, in some embodiments, processing subsystem 1110 may implement various processes (or portions thereof) described above as being implemented by a controller. Processing subsystem 1110 may also execute other programs to control other functions of controller 1100, including programs that may be stored in storage device 1112. In some embodiments, these programs may interact with an accessory, e.g., by generating messages to be sent to the accessory or receiving messages from the accessory. Such messages may conform to a uniform accessory protocol as described above.

Communication interface 1116 may provide voice or data communication capability for controller 1100. In some embodiments, communication interface 1116 may include radio frequency (RF) transceiver components for accessing wireless voice or data networks (e.g., using cellular telephone technology, data network technology such as 5G, 4G/LTE, Wi-Fi® (IEEE 802.11 family standards), or other mobile communication technologies, or any combination thereof), components for short-range wireless communication (e.g., using Bluetooth® or Bluetooth® LE standards, NFC, etc.), or other components. In some embodiments, communication interface 1116 may provide wired network connectivity (e.g., Ethernet) in addition to or instead of a wireless interface. Communication interface 1116 may be implemented using a combination of hardware (e.g., driver circuits, antennas, modulators/demodulators, encoders/decoders, and other analog or digital signal processing circuits) and software components. In some embodiments, communication interface 1116 may support multiple communication channels concurrently, using the same transport or different transports.

The secure element 1118 may be an integrated circuit or the like that may securely store cryptographic information for controller 1100. Examples of information that may be stored within the secure element 1118 include the controller's long-term public and secret keys (LTPKC, LTSKC as described above) and a list of paired accessories (e.g., a lookup table that maps accessory ID to accessory long-term public key LTPKA for accessories that have completed a pair setup or pair add process as described above).

In some embodiments, cryptographic operations may be implemented in a cryptographic logic module 1120 that communicates with the secure element 1118. Physically, cryptographic logic module 1120 may be implemented in the same integrated circuit with the secure element 1118 or a different integrated circuit (e.g., a processor in processing subsystem 1110) as desired. Cryptographic logic module 1120 may include various logic circuits (fixed or programmable as desired) that implement or support cryptographic operations of controller 1100, including any or all cryptographic operations described above. The secure element 1118 or cryptographic logic module 1120 may appear as a “black box” to the rest of controller 1100. Thus, for instance, communication interface 1116 may receive a message in an encrypted form that it cannot decrypt and may simply deliver the message to processing subsystem 1110. Processing subsystem 1110 may also be unable to decrypt the message, but it may recognize the message as encrypted and deliver it to cryptographic logic module 1120. Cryptographic logic module 1120 may decrypt the message (e.g., using information extracted from the secure element 1118) and determine what information to return to processing subsystem 1110. As a result, certain information may be available only within the secure element 1118 and cryptographic logic module 1120. If secure clement 1118 and cryptographic logic module 1120 are implemented on a single integrated circuit that executes code only from a secure internal repository, this may make extracting the information extremely difficult, providing a high degree of security. Other implementations are also possible.

The various examples further can be implemented in a wide variety of operating environments, which in some cases can include one or more user computers, computing devices, or processing devices that can be used to operate any of a number of applications. User or client devices can include any of a number of general-purpose personal computers, such as desktop or laptop computers running a standard operating system, as well as cellular, wireless, and handheld devices running mobile software and capable of supporting a number of networking and messaging protocols. Such a system can also include a number of workstations running any of a variety of commercially available operating systems and other known applications for purposes such as development and database management. These devices also can include other electronic devices, such as dummy terminals, thin-clients, gaming systems, and other devices capable of communicating via a network.

Most examples utilize at least one network that would be familiar to those skilled in the art for supporting communications using any of a variety of commercially available protocols, such as TCP/IP, OSI, FTP, UPnP, NFS, CIFS, and AppleTalk. The network can be, for example, a local area network, a wide-area network, a virtual private network, the Internet, an intranet, an extranet, a public switched telephone network, an infrared network, a wireless network, and any combination thereof.

In examples utilizing a network server, the network server can run any of a variety of server or mid-tier applications, including HTTP servers, FTP servers, CGI servers, data servers, Java servers, and business application servers. The server(s) may also be capable of executing programs or scripts in response to requests from user devices, such as by executing one or more applications that may be implemented as one or more scripts or programs written in any programming language, such as Java®, C, C# or C++, or any scripting language, such as Perl, Python or TCL, as well as combinations thereof. The server(s) may also include database servers, including without limitation those commercially available from Oracle®, Microsoft®, Sybase®, and IBM®.

The environment can include a variety of data stores and other memory and storage media, as discussed above. These can reside in a variety of locations, such as on a storage medium local to (and/or resident in) one or more of the computers or remote from any or all of the computers across the network. In a particular set of examples, the information may reside in a storage-area network (SAN) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices, such as RAM or ROM, as well as removable media devices, memory cards, flashcards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a non-transitory computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or browser. It should be appreciated that alternate examples may have numerous variations from that described above. For example, customized hardware might also be used, and/or particular elements might be implemented in hardware, software (including portable software, such as applets), or both. Further, connection to other computing devices, such as network input/output devices, may be employed.

Non-transitory storage media and computer-readable media for containing code, or portions of code, can include any appropriate media known or used in the art, including storage media, such as, but not limited to, volatile and nonvolatile, removable and non-removable media implemented in any method or technology for storage of information such as computer-readable instructions, data structures, program modules, or other data, including RAM, ROM, EEPROM, flash memory or other memory technology, CD-ROM, DVD or other optical storage, magnetic cassettes, magnetic tape, magnetic disk storage or other magnetic storage devices, or any other medium which can be used to store the desired information and which can be accessed by a system device. Based at least in part on the disclosure and teachings provided herein, a person of ordinary skill in the art will appreciate other ways and/or methods to implement the various examples.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated examples thereof are shown in the drawings and have been described above in detail. It should be understood, however, that there is no intention to limit the disclosure to the specific form or forms disclosed, but on the contrary, the intention is to cover all modifications, alternative constructions, and equivalents falling within the spirit and scope of the disclosure, as defined in the appended claims.

The use of the terms “a” and “an” and “the” and similar referents in the context of describing the disclosed examples (especially in the context of the following claims) are to be construed to cover both the singular and the plural unless otherwise indicated herein or clearly contradicted by context. The terms “comprising,” “having,” “including,” and “containing” are to be construed as open-ended terms (e.g., meaning “including, but not limited to,”) unless otherwise noted. The term “connected” is to be construed as partly or wholly contained within, attached to, or joined together, even if there is something intervening. Recitation of ranges of values herein is merely intended to serve as a shorthand method of referring individually to each separate value falling within the range unless otherwise indicated herein, and each separate value is incorporated into the specification as if it were individually recited herein. All methods described herein can be performed in any suitable order unless otherwise indicated herein or otherwise clearly contradicted by context. The use of any and all examples or exemplary language (e.g., “such as”) provided herein is intended merely to better illuminate examples of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present. The phrase “based on A” means “based at least in part on A,” for example, it could be “based solely on A,” or it could be “based in part on A.”

Preferred examples of this disclosure are described herein, including the best mode known to the inventors for carrying out the disclosure. Variations of those preferred examples may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

Flow diagrams, as illustrated herein, provide examples of sequences of various process actions. The flow diagrams can indicate operations to be executed by a software or firmware routine and physical operations. A flow diagram can illustrate an example of the implementation of states of a finite state machine (FSM), which can be implemented in hardware or software. Although shown in a particular sequence or order, the order of the actions can be modified unless otherwise specified. Thus, the illustrated diagrams should be understood only as examples, and the process can be performed in a different order, and some actions can be performed in parallel. Additionally, one or more actions can be omitted; thus, not all implementations will perform all actions.

To the extent various operations or functions are described herein, they can be described or defined as software code, instructions, configuration, or data. The content can be directly executable (“object” or “executable” form), source code, or difference code (“delta” or “patch” code). The software content of what is described herein can be provided via an article of manufacture with the content stored thereon or via a method of operating a communication interface to send data via the communication interface. A machine-readable storage medium can cause a machine to perform the functions or operations described and includes any mechanism that stores information in a form accessible by a machine (e.g., computing device, electronic system, etc.), such as recordable/non-recordable media (e.g., read-only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters or sending signals to prepare the communication interface to provide a data signal describing the software content. The communication interface can be accessed via one or more commands or signals sent to the communication interface.

The detailed description refers to the accompanying drawings. The same reference numbers may be used in different drawings to identify the same or similar elements. In the above description, for purposes of explanation and not limitation, specific details are set forth, such as particular structures, architectures, interfaces, or techniques, to provide a thorough understanding of the various aspects of some embodiments. However, it will be apparent to those skilled in the art having the benefit of the present disclosure that the various aspects of the various aspects may be practiced in other examples that depart from these specific details. In certain instances, descriptions of well-known devices, circuits, and methods are omitted so as not to obscure the description of the various aspects with unnecessary detail.

Various components described herein can be a means for performing the operations or functions described. Each component herein includes software, hardware, or a combination. The components can be implemented as software modules, hardware modules, special-purpose hardware (e.g., application-specific hardware, application-specific integrated circuits (ASICs), digital signal processors (DSPs), etc.), embedded controllers, hardwired circuitry, etc.

Besides what is described herein, various modifications can be made to what is disclosed and implementations of the invention without departing from their scope. Therefore, the illustrations and examples herein should be construed in an illustrative and not restrictive sense. The scope of the invention should be measured solely by reference to the claims that follow.

Although the aspects above have been described in considerable detail, numerous variations and modifications will become apparent to those skilled in the art once the above disclosure is fully appreciated. Accordingly, the following claims are intended to be interpreted to embrace all such variations and modifications.

### Privacy

As described above, one aspect of the present technology is the gathering and use of data relevant to a user's location and associated devices. The present disclosure contemplates that, in some instances, this gathered data may include personally identifiable information (PII) data that uniquely identifies or can be used to contact or locate a specific person. Such personal information data can include demographic data, location-based data, telephone numbers, email addresses, Twitter IDs, home addresses, data or records relating to a user's health or level of fitness (e.g., vital sign measurements, medication information, exercise information), date of birth, health record data, or any other identifying or personal or health information.

The present disclosure recognizes that the use of such personal information data, in the present technology, can be used to the benefit of users. For example, personal information data can be used to provide enhancements to a user's experience with mapping services. Further, other uses for personal information data that benefit the user are also contemplated by the present disclosure.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the U.S., collection of or access to certain health data may be governed by federal and/or state laws, such as the Health Insurance Portability and Accountability Act (HIPAA), whereas health data in other countries may be subject to other regulations and policies and should be handled accordingly. Hence, different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of updating the home location of a home automation system, the present technology can be configured to allow users to select “opt-in” or “opt-out” of participation in the collection of personal information data during registration for services or anytime thereafter. In addition to providing “opt-in” and “opt-out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health-related applications, data de-identification can be used to protect a user's privacy. De-identification may be facilitated, when appropriate, by removing specific identifiers (e.g., date of birth), controlling the amount or specificity of data stored (e.g., collecting location data at a city level rather than at an address level), controlling how data is stored (e.g., aggregating data across users), and/or other methods.

Therefore, although the present disclosure broadly covers the use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

What is claimed is:

1. A method for implementing transmission of ranging signals and data by a first device, the method comprising:
determining, by the first device, a schedule comprising a transmission schedule and a reception schedule;
transmitting, by the first device and to one or more other devices, a first packet based at least in part on the transmission schedule, the first packet comprising a first ranging signal and first audio data; and
receiving, by the first device and from a second device of the one or more other devices, a second packet based at least in part on the reception schedule, the second packet comprising a second ranging signal and second audio data.

2. The method of claim 1, further comprising:
receiving, by the first device and from a third device of the one or more other devices, a third packet based at least in part on the reception schedule, the third packet comprising a third ranging signal and third audio data;
obtaining, by the first device, first device audio data; and
generating, by the first device, the first audio data based at least in part on the first device audio data and the third audio data.

3. The method of claim 2, further comprising:
determining, by the first device, a fourth device of the one or more other devices based at least in part on the transmission schedule; and
determining, by the first device, a transmission configuration based at least in part on a channel condition associated with the fourth device of the one or more other devices.

4. The method of claim 3, wherein the transmitting, by the first device to the one or more other devices, comprises:
transmitting, by the first device to the fourth device of the one or more other devices based at least in part on the transmission schedule and the transmission configuration, the first packet comprising at least the generated first audio data.

5. The method of claim 1, further comprising:
generating, by the first device, the first audio data comprising first device audio data;
determining, by the first device and based at least in part on the transmission schedule, a third device of the one or more other devices and a fourth device of the one or more other devices;
determining, by the first device, a first channel condition associated with the third device of the one or more other devices;
determining, by the first device, a second channel condition associated with the fourth device of the one or more other devices; and
determining, by the first device, a transmission configuration based at least in part on the first channel condition associated with the third device of the one or more other devices and the second channel condition associated with the fourth device of the one or more other devices.

6. The method of claim 5, wherein transmitting, by the first device and to the one or more other devices, comprises:
transmitting, by the first device to the third device of the one or more other devices, the first packet based at least in part on the transmission schedule and the transmission configuration, the first packet based comprising the generated first audio data; and
transmitting, by the first device and to the fourth device of the one or more other devices, the first packet based at least in part on the transmission schedule and the transmission configuration, the first packet comprising the generated first audio data.

7. The method of claim 1, further comprising:
determining, by the first device, a retransmission of the first packet; and
transmitting, by the first device and to the one or more other devices, a third packet based at least in part on the transmission schedule, the third packet comprising the first audio data.

8. The method of claim 1, further comprising:
determining, by the first device, a retransmission of the first packet; and
transmitting, by the first device and to the one or more other devices, a third packet based at least in part on the transmission schedule, the third packet comprising the first audio data and a third audio data.

9. The method of claim 1, further comprising:
obtaining, by the first device, a list of devices associated with the one or more other devices;
determining, by the first device, a change in the list of devices associated with the one or more other devices; and
updating, by the first device, the schedule based at least in part on the determination of the change in the list of devices associated with the one or more other devices.

10. The method of claim 9, wherein the change in the list of devices associated with the one or more other devices comprises adding, by the first device, an indication of a third device to the list of devices or removing, by the first device, an indication of a third device from the list of devices.

11. The method of claim 1, the method further comprising:
determining, by the first device, a relative direction of the second device based on second ranging signal; and
configuring a setting to associate a replay of one or more audio data based on the relative direction.

12. A non-transitory computer-readable medium storing computer-executable instructions that, when executed by one or more processors of a first device, configure the one or more processors to perform operations comprising:
determining, by the first device, a schedule comprising a transmission schedule and a reception schedule;
transmitting, by the first device and to one or more other devices, a first packet based at least in part on the transmission schedule, the first packet comprising a first ranging signal and first audio data; and
receiving, by the first device and from a second device of the one or more other devices, a second packet based at least in part on the reception schedule, the second packet comprising a second ranging signal and second audio data.

13. The non-transitory computer-readable medium of claim 12, wherein the instructions, when executed by the one or more processors, configure the one or more processors to further perform operations comprising:
receiving, by the first device and from a third device of the one or more other devices, a third packet based at least in part on the reception schedule, the third packet comprising a third ranging signal and third audio data;
obtaining, by the first device, first device audio data; and
generating, by the first device, the first audio data based at least in part on the first device audio data and the third audio data.

14. The non-transitory computer-readable medium of claim 13, wherein the instructions, when executed by the one or more processors, configure the one or more processors to further perform operations comprising:
determining, by the first device, a fourth device of the one or more other devices based at least in part on the transmission schedule; and
determining, by the first device, a transmission configuration based at least in part on a channel condition associated with the fourth device of the one or more other devices.

15. The non-transitory computer-readable medium of claim 14, wherein the instructions, when executed by the one or more processors, configure the one or more processors to further perform operations comprising:
transmitting, by the first device to the fourth device of the one or more other devices based at least in part on the transmission schedule and the transmission configuration, the first packet comprising at least the generated first audio data.

16. The non-transitory computer-readable medium of claim 12, wherein the instructions, when executed by the one or more processors, configure the one or more processors to further perform operations comprising:
generating, by the first device, the first audio data comprising first device audio data;
determining by the first device, a third device of the one or more other devices and a fourth device of the one or more other devices;
determining, by the first device, a first channel condition associated with the third device of the one or more other devices;
determining, by the first device, a second channel condition associated with the fourth device of the one or more other devices; and
determining, by the first device, a transmission configuration based at least in part on the first channel condition associated with the third device of the one or more other devices and the second channel condition associated with the fourth device of the one or more other devices.

17. The non-transitory computer-readable medium of claim 16, wherein the instructions, when executed by the one or more processors, configure the one or more processors to further perform operations comprising:
transmitting, by the first device and to the third device of the one or more other devices, the first packet based at least in part on the transmission schedule and the transmission configuration, the first packet comprising the generated first audio data; and
transmitting, by the first device and to the fourth device of the one or more other devices, the first packet based at least in part on the transmission schedule and the transmission configuration, the first packet comprising the generated first audio data.

18. A first device comprising:
a memory configured to store computer-executable instructions; and
one or more processors configured to access the memory and execute computer-executable instructions to cause the first device to at least:
determine, by the first device, a schedule comprising a transmission schedule and a reception schedule,
transmit, by the first device and to one or more other devices, a first packet based at least in part on the transmission schedule, the first packet comprising a first ranging signal and first audio data, and
receive, by the first device and from a second device of the one or more other devices, a second packet based at least in part on the reception schedule, the second packet comprising a second ranging signal and second audio data.

19. The first device of claim 18, wherein the computer-executable instructions further cause the first device to:
receive, by the first device and from a third device of the one or more other devices, a third packet based at least in part on the reception schedule, the third packet comprising a third ranging signal and third audio data;
obtain, by the first device, first device audio data;
generate, by the first device, the first audio data based at least in part on the first device audio data and the third audio data;
determine, by the first device, a fourth device of the one or more other devices based at least in part on the transmission schedule;
determine, by the first device, a transmission configuration based at least in part on a channel condition associated with the fourth device of the one or more other devices; and
wherein to transmit, by the first device to the one or more other devices, comprises to:
transmit, by the first device to the fourth device of the one or more other devices based at least in part on the transmission schedule and based at least in part on the transmission configuration, the first packet comprising at least the generated first audio data.

20. The first device of claim 18, wherein the computer-executable instructions further cause the first device to:
generate, by the first device, the first audio data comprising first device audio data;
determine by the first device, a third device of the one or more other devices and a fourth device of the one or more other devices;
determine, by the first device, a first channel condition associated with the third device of the one or more other devices;
determine, by the first device, a second channel condition associated with the fourth device of the one or more other devices;
determine, by the first device, a transmission configuration based at least in part on the first channel condition associated with the third device of the one or more other devices and the second channel condition associated with the fourth device of the one or more other devices; and
wherein to transmit, by the first device and to the one or more other devices, comprises to:
transmit, by the first device and to the third device of the one or more other devices, the first packet based at least in part on the transmission schedule and the transmission configuration, the first packet comprising the generated first audio data, and
transmit, by the first device and to the fourth device of the one or more other devices, the first packet based at least in part on the transmission schedule and the transmission configuration, the first packet comprising the generated first audio data.
